(19) United States
(12) Patent Application Publication
(10) Pub. No.: US 2012/0042825 A1
(43) Pub. Date: Feb. 23, 2012

(54) EXTENDED LIFE DEPOSITION RING

(75) Inventor: Lara Hawrylchak, Gilroy, CA (US)

(73) Assignee: APPLIED MATERIALS, INC., Santa Clara, CA (US)

(21) Appl. No.: 13/195,370

(22) Filed: Aug. 1, 2011

Related U.S. Application Data
(60) Provisional application No. 61/375,705, filed on Aug. 20, 2010.

(51) Int. Cl. B05C 11/00

(52) U.S. Cl. 118/504

(57) ABSTRACT

A process kit for a semiconductor processing chamber is provided. In one embodiment, a process kit includes an annular deposition ring body comprising a trough recessed into an upper surface of the body wherein a lowest point of the trough extends to at least half of the thickness of the ring body as defined by a top wall and a bottom wall. In another embodiment, a process kit includes an annular deposition ring body comprising a sloped upper wall defining at least a portion of an upper surface of the body, wherein a peak of the sloped upper wall extends from an inner wall of the body to at least half of a distance between the inner wall and an outer wall of the body.

### CROSS-REFERENCE TO RELATED APPLICATIONS

This application claims benefit of U.S. provisional patent application Ser. No. 61/375,705 (Attorney Docket No. 15192L), filed Aug. 20, 2010, which is herein incorporated by reference in its entirety.

### BACKGROUND OF THE INVENTION

1. Field of the Invention

Embodiments of the present invention generally relate to a process kit for a semiconductor processing chamber, and more specifically, to a deposition ring.

2. Description of the Related Art

In deposition processes, species from a source such as a target, a gas inlet manifold or other suitable source, may deposit on exposed internal chamber surfaces, including chamber walls, substrate pedestal assemblies, electrostatic chucks and other hardware. Process kits, such as shield assemblies, have been developed that circumscribe the electrostatic chuck within a semiconductor processing system to protect the chuck from exposure to the deposition species within the system. One shield assembly includes a removable cover ring and a deposition ring.

The deposition ring rests upon a circumferential flange extending from an outer edge of the electrostatic chuck. The support surface of the chuck, upon which a substrate is retained, has a diameter that is slightly smaller than the diameter of a substrate. Consequently, a substrate retained by the chuck overhangs an inner portion of the top surface of the deposition ring. The cover ring circumscribes and rests upon an outer portion of the deposition ring. The cover ring has a lip that overhangs the outer portion but does not contact a top surface of the deposition ring, thereby defining a labyrinth gap between the cover and deposition rings. The labyrinth gap separating the rings prevents deposition species from passing between the space and into contact with the electrostatic chuck.

Although shield assemblies having the above-described configuration have demonstrated robust performance, improvements are desired that reduce the potential for particulate generation within the chamber and/or enhance longer production runs between replacement of the rings for cleaning. For example, deposition build-up on the rings may lead to undesirable electrical bridging between the rings that adversely affect process performance, thereby requiring periodic ring replacement for cleaning.

Therefore, there is a need for an improved process kit.

### SUMMARY OF THE INVENTION

In one embodiment, a process kit is provided that includes an annular deposition ring body comprising, an inner wall, an outer wall, a sloped upper wall defining at least a portion of an upper surface of the body, a top wall, a bottom wall, and a trough recessed into the upper surface of the body between the top wall and the inner wall, wherein a lowest point of the trough extends to at least half of the distance between the top wall and bottom wall.

In another embodiment, a process kit is provided including an annular deposition ring body comprising, an inner wall, an outer wall, a sloped upper wall defining at least a portion of an upper surface of the body, a top wall, a bottom wall, and a trough recessed into an upper surface of the body between the top wall and the inner wall, wherein a peak of the sloped upper surface extends from the inner wall to at least half of a distance between the inner wall and outer wall.

In another embodiment, a process kit is provided including an annular deposition ring body comprising, an inner wall, an outer wall, a sloped upper wall defining at least a portion of an upper surface of the body, a top wall, a bottom wall, a trough recessed into an upper surface of the body between the top wall and the inner wall, and a land positioned radially inward of the outer wall and parallel to the bottom wall, and a cover ring having a ledge positioned to mate with the land of the ring body, wherein the cover ring comprises a lip positioned to form a labyrinth gap with the top wall of the ring body when the ledge of the cover ring is mated with the land of the ring body.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial sectional view of a substrate support having one embodiment of a deposition ring disposed thereon.

FIG. 2 is a top perspective view of the deposition ring of FIG. 1.

FIG. 3 is a cross-sectional view of the deposition ring taken along section line 3-3 of FIG. 2.

FIG. 4 is an enlarged sectional view of a portion of the deposition ring of FIG. 3.

FIG. 5 is an enlarged sectional view of another portion of the deposition ring of FIG. 3.

### DETAILED DESCRIPTION

Embodiments of the invention generally provide a process kit for use in a semiconductor processing chamber. The process kit advantageously includes a deposition ring having at least one feature that promotes longer surface life and/or process uniformity. Embodiments of the invention find utility in several semiconductor processing chambers, including chemical vapor deposition chambers and physical vapor deposition, chambers among others.

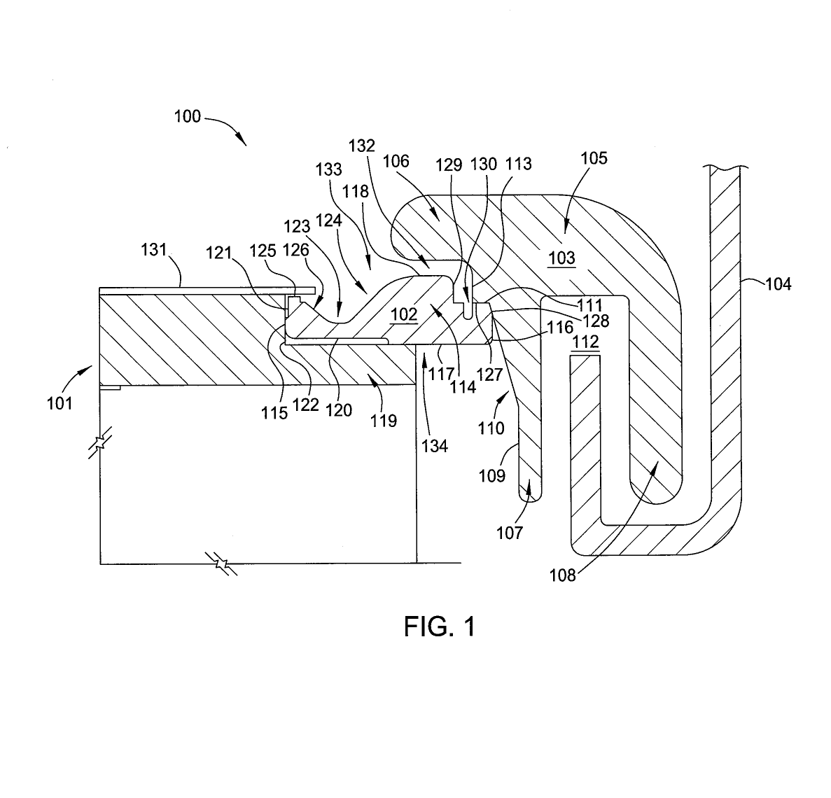

FIG. 1 is a partial sectional view of a substrate support 101 interfaced with a process kit 100. The process kit 100 may include one or more of a deposition ring 102, a cover ring 103, and a shield 104. The substrate support 101 is positioned within a processing chamber (not shown). The shield 104 may be positioned around the substrate support and coupled to the processing chamber. The cover ring 103 generally has an annular body 105. The body 105 may be fabricated from a metal such as stainless steel, aluminum oxide, titanium or other suitable material. The body 105 generally includes a lip 106 that extends radially inward and provides an upper boundary of a labyrinth gap 132 defined between the deposition ring 102 and the cover ring 103.

The body 105 of the cover ring 103 also includes an inner ring 107 and an outer ring 108. The rings 107, 108 extend downward from the body 105 in a spaced apart relation that defines a slot 112. The slot 112 has an open end facing downward to allow engagement with the end of the shield 104.

A tapered section 110 is defined on the upper section of an inner wall 109 of the inner ring 107. The tapered section 110 extends gradually inward from the inner wall 109 and terminates at a ledge 111 formed on a lower surface of the body 105. The tapered section 110 allows the cover ring 103 and deposition ring 102 to self-align as the rings 102, 103 come into contact with each other.

The ledge 111 is generally horizontal and perpendicular to the central axis of the cover ring 103. The ledge 111 provides a bearing surface of the cover ring 103 which is supported by the deposition ring 102. The ledge 111 is generally smooth and planar to allow repeatable and consistent mating between the ledge 111 and the deposition ring 102. This is critical due to the tolerances of the labyrinth gap 132. The ledge 111 is further adapted to slide along the deposition ring 102, if necessary, with minimal particulate generation.

The inside edge of the ledge 111 terminates in a wall 113. The wall 113 is substantially vertical and extends between the ledge 111 and the lip 106. The wall 113 is radially inward of the inner ring 107, and radially outward of the lip 106. The wall 113 forms part of the boundary of the labyrinth gap 132.

The deposition ring 102 generally comprises an annular body 114. The body 114 may be fabricated from a ceramic material, such as quartz, aluminum oxide or other suitable material. The body 114 generally includes an inner wall 115, an outer wall 116, a bottom wall 117 and a top wall 118. The inner and outer walls 115, 116 respectively define the innermost and outermost diameters of the body 114. The top and bottom walls 118, 117 respectively define a portion of an uppermost surface 133 and a lowermost surface 134 of the body 114.

The bottom wall 117 is configured to support the deposition ring 102 on a flange 119 of the substrate support 101. The bottom wall 117 is generally perpendicular to a central axis of the deposition ring 102 to maintain parallelism with the flange 119 of the substrate support 101 and with a substrate 131 positioned on the substrate support 101. The bottom wall 117 is planar and smooth to facilitate repeatable and consistent mating between the bottom wall 117 and the flange 119. This is critical due to the tolerances of the gap between an inner edge 125 of the deposition ring 102 and the substrate 131. It is very important that inner edge 125 sit beneath the substrate 131 with the smallest physical gap possible without contact. If the gap is too wide there may be deposition onto the substrate support 101, and if the gap is too small, or the deposition ring 102 contacts the substrate 131, possible backside plasma/arcing may occur due to power potential differences of the components. The bottom wall 117 is further adapted to slide along the flange 119, if necessary, due to thermal expansion and/or contraction of the deposition ring 102 relative to the substrate support 101.

The lowermost surface 134 of the body 114 also includes a recessed portion 120 formed between the bottom wall 117 and the inner wall 115. The recessed portion 120 minimizes the contact area between the flange 119 of the substrate support 101 and the deposition ring 102. The reduced contact area between the deposition ring 102 and the substrate support 101 reduces friction while minimizing particulate generation as the deposition ring 102 moves on the flange 119 of the substrate support 101.

An upper inner wall 121 is also recessed from the inner wall 115. The upper inner wall 121 minimizes the contact area between the body 114 and a wall 122 of the substrate support 101.

The uppermost surface 133 of the body 114 also includes the inner edge 125 and a trough 123 formed radially inward of the top wall 118. The trough 123 includes an outward and upward sloping upper outer wall 124 and an inward and upward sloping upper inner wall 126. The thickness of the body 114 increases radially inward of the center of the trough 123 as the inward and upward sloping upper inner wall 126 of the uppermost surface 133 of the body 114 slopes upward toward the inner edge 125. The inner edge 125 is at a higher elevation than the trough 123 relative to the bottom wall 117, and at a lower elevation relative to the top wall 118. The trough 123 provides a collection area spaced from both the substrate 131 and cover ring 103 so that materials deposited on the deposition ring 102 do not contact the substrate 131 or inhibit movement of the rings 102, 103. Additionally, the inward and upward sloping upper inner wall 126 of the body 114 defined between the inner edge 125 and the trough 123 provides an orientation that inhibits particles and deposition material from traveling into the gap defined between the inner edge 125 and the substrate 131.

The outer wall 116 of the body 114 has a diameter selected such that the deposition ring 102 and cover ring 103 remain engaged through a wide range of processing temperatures. In the embodiment depicted in FIG. 1, the outer wall 116 has a diameter greater than an inside diameter of the wall 113 of the cover ring 103, and less than an inside diameter of the tapered section 110 of the cover ring 103.

A land 127 is formed between the outer wall 116 and the top wall 118 to support the cover ring 103. The land 127 is generally horizontal and perpendicular to the central axis of the deposition ring 102. The land 127 is configured to support the ledge 111 of the cover ring 103. The land 127 is generally smooth and planar to allow the ledge 111 to slide along the land 127 as the rings 102, 103 self-align. The land 127 may have a tapered section 128 formed between the land 127 and the outer wall 116 formed at a similar angle as the tapered section 110 of the cover ring 103 to assist the rings 102, 103 in aligning.

The body 114 includes an upper outer wall 129 connecting the land 127 and the top wall 118. The top wall 118 and upper outer wall 129 have dimensions selected such that the deposition ring 102 and the lip 106 of the cover ring 103 interleave in a spaced apart relation to define the labyrinth gap 132 therebetween. In the embodiment depicted in FIG. 1, the upper outer wall 129 has a diameter greater than an inside diameter of the lip 106 of the cover ring 103, and less than a diameter of the wall 113 of the cover ring 103. The spacing between the upper outer wall 129 of the deposition ring 102 and the wall 113 of the cover ring 103 is selected to maintain a spaced apart relation between the rings 102, 103, even after the rings 102, 103 have been coated with up to about 1000 micrometers of material during substrate deposition processes.

A notch 130 is formed into the land 127 between the outer wall 116 and the upper outer wall 129. The notch 130 provides an area for receiving material, disposed on the land 127, which is pushed by cover ring 103 towards the wall 129 as the ledge 111 of the cover ring 103 traverses across the land 127. As the material disposed on the land 127 may be displaced into the notch 130 as the cover ring 103 moves relative to the deposition ring 102, the material disposed on the land 127 is less likely to be forced between the land 127 and the ledge 111, thereby enhancing the retention of the parallel relation of the rings 102, 103 over the course of processing many substrates. Moreover, by having an area for material to be received as the cover ring 103 moves relative to the deposition ring 102, the material disposed on the land 127 is less likely to prevent and/or limit the relative movement of the rings 102, 103. Moreover, due to the placement of the notch 130, deposition build-up and bridging between the rings 102, 103 is less likely than conventional designs. As such, the orientation and position of the notch 130 extends the service life of the deposition ring 102.

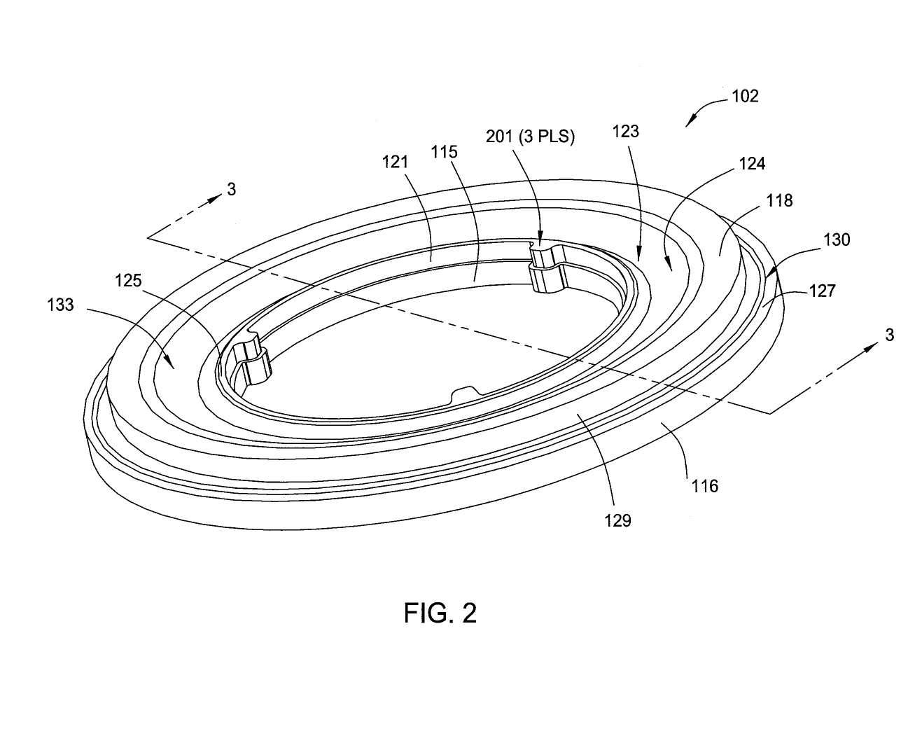

FIG. 2 is a top perspective view of the deposition ring 102 illustrating at least one tab 201. The at least one tab 201, such as, for example, three tabs shown in FIG. 2, extend from the inner wall 115 and upper inner wall 121 between the inner edge 125 and the recessed portion 120 of the deposition ring 102. The tabs 201 reduce the amount of contact between the wall 122 of the substrate support 101 and the deposition ring 102, while keeping the deposition ring 102 generally centered on the substrate support 101. The tabs 201 are further configured to align with one or more notches (not shown) of the substrate 131. The tabs 201 provide additional deposition protection for the substrate support 101 since deposition material may come through the notches of the substrate 131.

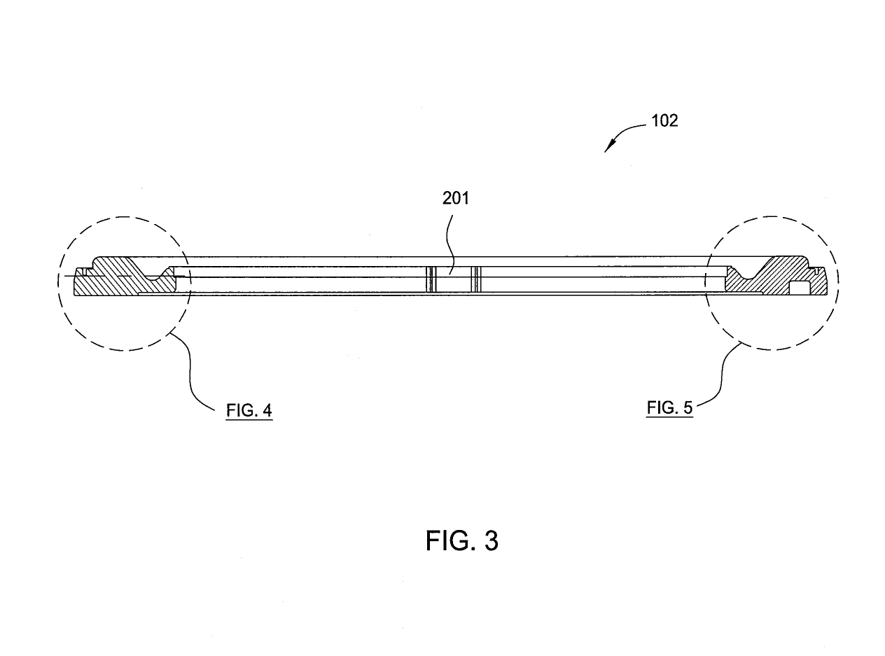

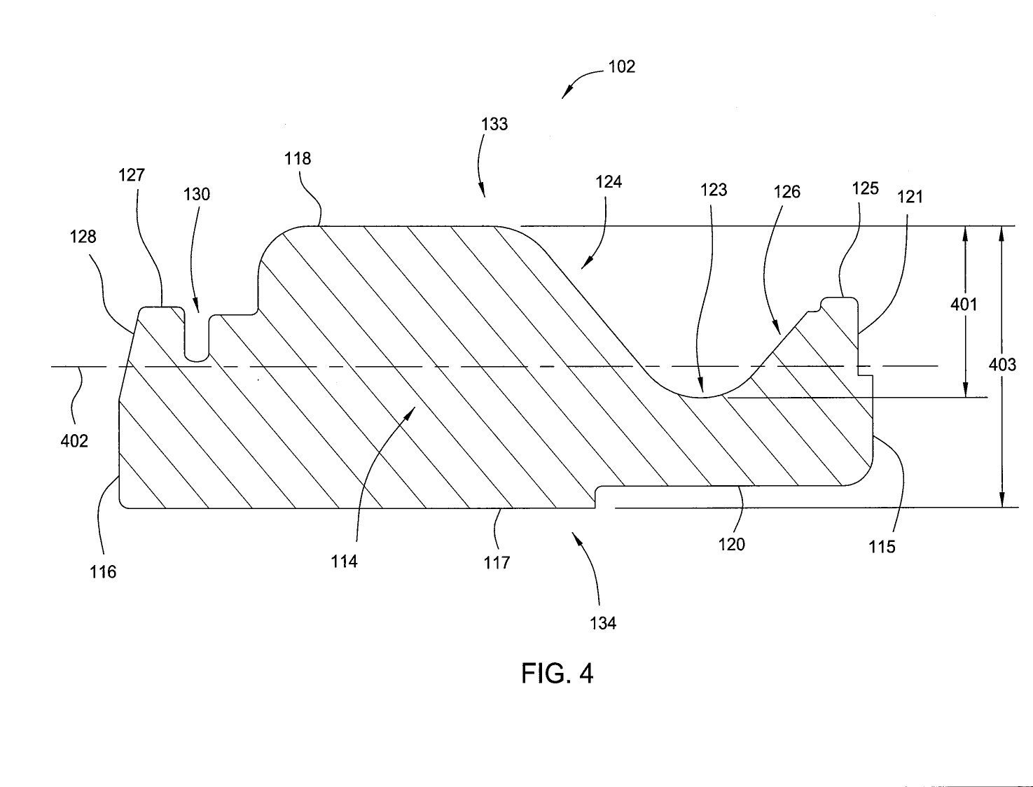

FIG. 3 is a cross-sectional view of the deposition ring 102 taken through section line 3-3 of FIG. 2. FIGS. 4 & 5 are enlarged views of portions of the deposition ring 102 shown in FIG. 3. Referring now to FIG. 4, a thickness 403 of the deposition ring 102 may be defined between the top wall 118 and the bottom wall 117. A half thickness of the deposition ring is indicated by a centerline 402. The trough 123 may extend from the top wall 118 to at or below the half thickness at its lowest point. For example, as shown in FIG. 4, the lowest point of the trough 123 may extend beyond the centerline 402 to a depth 401. Having the trough 123 extend deeply into the body 114 may extend the life of the deposition ring 102 because more extraneous deposition material may be retained in the trough 123 before contact occurs between the substrate 131 and the built up deposition material.

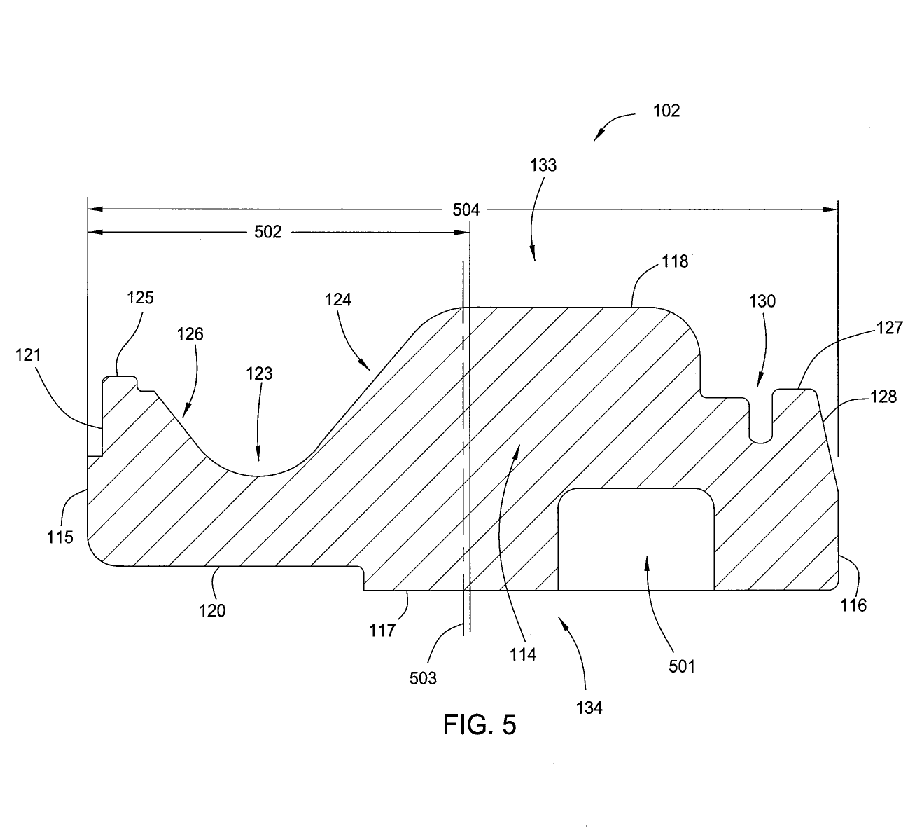

Referring now to FIG. 5, a width 504 of the deposition ring 102 may be defined between the inner wall 115 and the outer wall 116. A half width of the deposition ring is indicated by a centerline 503 in FIG. 5. A peak distance 502 of the outward and upward sloping upper outer wall 124 may extend from the inner wall 115 to or past the half thickness of the deposition ring 102. For example, the outward and upward sloping upper outer wall 124 extends beyond the centerline 402 as shown in FIG. 5. The peak of the outward and upward sloping upper outer wall 124 may be defined where the slope of outward and upward sloping upper outer wall 124 transitions from an upward slope to a horizontal or downward slope. Having the outward and upward sloping upper outer wall 124 comprise a high percentage of the uppermost surface 133 of the deposition ring 102 may extend the life of the deposition ring 102 because more extraneous deposition material may be held before contact occurs between the substrate 131 or the cover ring 103 with deposition material built up on the deposition ring 102.

In order to provide a measure of orientation of the deposition ring 102 within the chamber, one or more slots 501 may be provided as shown in FIG. 5. The slot 501 may be engaged with a feature (not shown) extending from at least one of the substrate support 101 and/or shield 104. As the slot 501 facilitates maintaining the ring 102 and tabs 201 in a known orientation, the substrate 131 may be provided in a complimentary orientation.

Thus, a deposition ring has been provided that facilitates substrate deposition processes with reduced processing defects due to shorting and/or material bridging between the ring and substrate.

While the foregoing is directed to the preferred embodiments of the present invention, other and further embodiments of the invention may be devised without departing from the basic scope thereof, and the scope thereof is determined by the claims that follow.

1. A process kit, comprising:
an annular deposition ring body comprising:
an inner wall;
an outer wall;
a sloped upper wall defining at least a portion of an upper surface of the ring body and upwardly sloping toward the outer wall;
a top wall positioned between the sloped upper wall and the outer wall;
a bottom wall separated from the top wall by a distance; and
a trough recessed into the upper surface of the ring body between the sloped upper wall and the inner wall, wherein a lowest point of the trough extends to at least half of the distance between the top wall and bottom wall.

2. The process kit of claim 1, wherein the ring body further comprises at least one notch extending into the body and towards the bottom wall between the outer wall and the top wall.

3. The process kit of claim 1, wherein the inner and outer walls are parallel, and wherein the top and bottom walls are perpendicular to the inner and outer walls.

4. The process kit of claim 1, wherein the ring body further comprises an upper inner wall positioned radially outward of the inner wall and parallel therewith.

5. The process kit of claim 1, wherein the ring body further comprises an inner edge defining at least a portion of the upper surface of the ring body, and wherein the inner edge is positioned radially outward of the inner wall and perpendicular thereto.

6. The process kit of claim 1, wherein the ring body further comprises a recessed portion which is recessed with respect to the bottom wall and is parallel thereto.

7. The process kit of claim 1, wherein the ring body further comprises a land positioned radially inward of the outer wall, and wherein the land is parallel to the bottom wall.

8. The process kit of claim 1, wherein the outer wall of the ring body comprises a tapered section adjacent the upper surface of the ring body.

9. The process kit of claim 1, wherein the ring body further comprises a slot extending into the bottom wall toward the upper surface of the ring body.

10. A process kit, comprising:
an annular deposition ring body comprising:
an inner wall;
an outer wall separated from the inner wall by a distance;
a sloped upper wall defining at least a portion of an upper surface of the ring body and upwardly sloping toward the outer wall, wherein a peak of the sloped upper wall extends from the inner wall to at least half of the distance between the inner wall and outer wall;
a top wall positioned between the sloped upper wall and the outer wall;
a bottom wall; and
a trough recessed into the upper surface of the ring body between the sloped upper wall and the inner wall.

11. The process kit of claim 10, wherein the ring body further comprises at least one notch extending into the body and towards the bottom wall between the outer wall and the top wall.

12. The process kit of claim 10, wherein the inner and outer walls are parallel, and wherein the top and bottom walls are perpendicular to the inner and outer walls.

13. The process kit of claim 10, wherein the ring body further comprises an upper inner wall positioned radially outward of the inner wall and parallel therewith.

14. The process kit of claim 10, wherein the ring body further comprises an inner edge defining at least a portion of the upper surface of the ring body, and wherein the inner edge is positioned radially outward of the inner wall and perpendicular thereto.

15. The process kit of claim 10, wherein the ring body further comprises a recessed portion which is recessed with respect to the bottom wall and is parallel thereto.

16. The process kit of claim 10, wherein the ring body further comprises a land positioned radially inward of the outer wall, and wherein the land is parallel to the bottom wall.

17. The process kit of claim 10, wherein the outer wall of the ring body comprises a tapered section adjacent the upper surface of the ring body.

18. The process kit of claim 10, wherein the ring body further comprises a slot extending into the bottom wall toward the upper surface of the ring body.

19. A process kit, comprising:
an annular deposition ring body comprising:
an inner wall;
an outer wall;
a sloped upper wall defining at least a portion of an upper surface of the ring body and upwardly sloping toward the outer wall;
a top wall positioned between the sloped upper wall and the outer wall;
a bottom wall;
a trough recessed into the upper surface of the ring body between the sloped upper wall and the inner wall; and
a land positioned radially inward of the outer wall and parallel to the bottom wall; and
a cover ring having a ledge positioned to mate with the land of the ring body, wherein the cover ring comprises a lip positioned to form a labyrinth gap with the top wall of the ring body when the ledge of the cover ring is mated with the land of the ring body.

20. The process kit of claim 19, wherein the inner and outer wall are separated by a first distance, wherein a peak of the sloped upper wall extends from the inner wall to at least half of the first distance between the inner wall and outer wall, wherein the top and bottom wall are separated by a second distance, and wherein a lowest point of the trough extends to at least half of the second distance between the top wall and bottom wall.
